(19) United States
(12) Patent Application Publication
(10) Pub. No.: US 2025/0153640 A1
(43) Pub. Date: May 15, 2025

(54) DIGITAL REAR MIRROR FOR DETECTING BLIND-SPOT VEHICLE OR PARKING AREA BASED ON REAR IMAGE OF VEHICLE AND OPERATING METHOD OF THE SAME

(71) Applicant: THINKWARE CORPORATION, SEONGNAM-SI (KR)

(72) Inventors: Soon Woo PARK, SEONGNAM-SI (KR); Kang Sik KIM, SEONGNAM-SI (KR)

(21) Appl. No.: 18/945,922

(22) Filed: Nov. 13, 2024

(30) Foreign Application Priority Data
Nov. 14, 2023 (KR) 10-2023-0157751
Nov. 11, 2024 (KR) 10-2024-0158860

(51) Int. Cl. B60R 1/12; B60R 1/04; B60W 30/06; B60W 30/12; B60W 50/14; G06V 20/58

(52) U.S. Cl. CPC B60R 1/12; B60R 1/04; B60W 30/06; B60W 30/12; B60W 50/14; G06V 20/586; B60R 2001/1215; B60R 2300/8026; B60R 2300/804; B60R 2300/806; B60R 2300/8093; B60W 2050/146; B60W 2420/403; B60W 2552/53

(57) ABSTRACT

The present disclosure provides a digital rear mirror device for detecting a blind-spot vehicle or an available parking area based on a rear view video of a vehicle and an operating method of the same. In the present disclosure, the digital rear mirror device is configured to acquire a rear view video of the vehicle, to analyze the rear view video and detect a blind-spot vehicle within an adjacent distance from the vehicle, and to output information for warning a collision with the blind-spot vehicle. Also, in the present disclosure, the digital rear mirror device is configured to acquire the rear view video of the vehicle, and to, in a reserve driving mode of the vehicle, analyze the rear view video and detect at least one available parking area for the vehicle, and to define the available parking area within the rear view video.

### CROSS-REFERENCE TO RELATED APPLICATION(S)

This application claims the priority benefit under 35 U.S.C. § 119 to Korean Patent Application No. 10-2023-0157751, filed on Nov. 14, 2023, and Korean Patent Application No. 10-2024-0158860, filed on Nov. 11, 2024, in the Korean Intellectual Property Office, the entire contents of which are incorporated herein by reference in their entirety.

### BACKGROUND

### 1. Field

The present disclosure relates to a digital rear mirror (DRM) device for detecting a blind-spot vehicle or an available parking area based on a rear view video of a vehicle and an operating method of the same.

### 2. Description of Related Art

In general, a vehicle is equipped with a blind-spot safety system that monitors blind-spot vehicles using a radar sensor. For example, a blind-spot collision warning (BCW) system and a blind-spot collision-avoidance assist (BCA) system may be included in the blind-spot safety system. The blind-spot collision warning (BCW) system provides information on a blind-spot vehicle to a driver. In detail, when the blind-spot vehicle is present within an adjacent distance or when the blind-spot vehicle approaches at high speed, the blind-spot collision warning (BCW) system displays warning information on, for example, a side mirror, a head up display (HUD), and a dashboard. The blind-spot collision-avoidance assist (BCA) system controls a vehicle to prevent a collision with the blind-spot vehicle when the vehicle changes lanes.

However, in the blind-spot safety system as above, a malfunction occurs depending on a surrounding environment due to a radar sensor. In addition, when a rear bumper of the vehicle is damaged, the radar sensor may also be damaged or a location of the radar sensor may change. Therefore, the blind-spot safety system as described above does not properly operate.

### SUMMARY

The present disclosure provides a digital rear mirror device for detecting a blind-spot vehicle or an available parking area based on a rear view video of a vehicle and an operating method of the same.

In the present disclosure, an operating method of a digital rear mirror device of a vehicle may include acquiring a rear view video of the vehicle; analyzing the rear view video and detecting a blind-spot vehicle within an adjacent distance from the vehicle; and outputting information for warning a collision with the blind-spot vehicle.

In the present disclosure, an operating method of a digital rear mirror device of a vehicle may include acquiring a rear view video of the vehicle; analyzing the rear view video; in a reserve driving mode of the vehicle, analyzing the rear view video and detecting at least one available parking area for the vehicle; and defining the available parking area within the rear view video.

In the present disclosure, a digital rear mirror device of a vehicle may include a digital rear mirror module; and a processor configured to connect to the digital rear mirror module, to acquire a rear view video during driving of the vehicle, and to display the rear view video on the digital rear mirror module, and the processor may be configured to analyze the rear view video and detect a blind-spot vehicle within an adjacent distance from the vehicle, and to output information for warning a collision with the blind-spot vehicle.

In the present disclosure, a digital rear mirror device of a vehicle may include a digital rear mirror module; and a processor configured to connect to the digital rear mirror module, to acquire a rear view video during driving of the vehicle, and to display the rear view video on the digital rear mirror module, and the processor may be configured to, in a reserve driving mode of the vehicle, analyze the rear view video and detect at least one available parking area for the vehicle, and to define the available parking area within the rear view video.

According to the present disclosure, a digital rear mirror device may promote the blind-spot safety for a vehicle while providing rear view of the vehicle. In detail, the digital rear mirror device may monitor the blind-spot safety of the corresponding vehicle by analyzing a rear view video and by detecting a blind-spot vehicle. This makes it possible for the digital rear mirror device to monitor the blind-spot vehicle regardless of a radar sensor. Therefore, the digital rear mirror device may prevent the vehicle from colliding with the blind-spot vehicle by warning a driver of a collision with the blind-spot vehicle or by allowing the vehicle to avoid changing lanes to an adjacent lane in which the blind-spot vehicle is present. Meanwhile, the digital rear mirror device may additionally monitor the rear safety in a reverse driving mode of the vehicle by analyzing the rear view video and by detecting an available parking area. Therefore, the digital rear mirror device may assist in parking the vehicle by informing the driver of the available parking area or by allowing the vehicle to execute parking in the available parking area.

### BRIEF DESCRIPTION OF THE DRAWINGS

FIG. 1 is a block diagram illustrating a configuration of a video processing system according to various example embodiments.

FIG. 2 is a flowchart illustrating signal flow for preventing a collision of a vehicle in a video processing system according to various example embodiments.

FIGS. 3A and 3B illustrate examples for describing operation characteristics of a digital rear mirror device for detecting a blind-spot vehicle of a vehicle according to various example embodiments.

FIG. 4 is a flowchart illustrating signal flow for a vehicle to execute parking in a video processing system according to various example embodiments.

FIG. 5 illustrates operation characteristics of a digital rear mirror device for detecting an available parking area of a vehicle according to various example embodiments.

FIG. 6 is a block diagram illustrating a configuration of a digital rear mirror device according to various example embodiments.

FIG. 7 is a flowchart illustrating an operating method of a digital rear mirror device for detecting a blind-spot vehicle of a vehicle according to various example embodiments.

FIG. 8 is a flowchart illustrating an operating method of a digital rear mirror device for detecting a parking are of a vehicle according to various example embodiments.

FIG. 9 is a block diagram illustrating a vehicle to which a video processing system is mounted according to various example embodiments.

FIG. 10 is a block diagram illustrating a control device of the vehicle of FIG. 9.

### DETAILED DESCRIPTION

Hereinafter, various example embodiments of the present document are described with reference to the accompanying drawings.

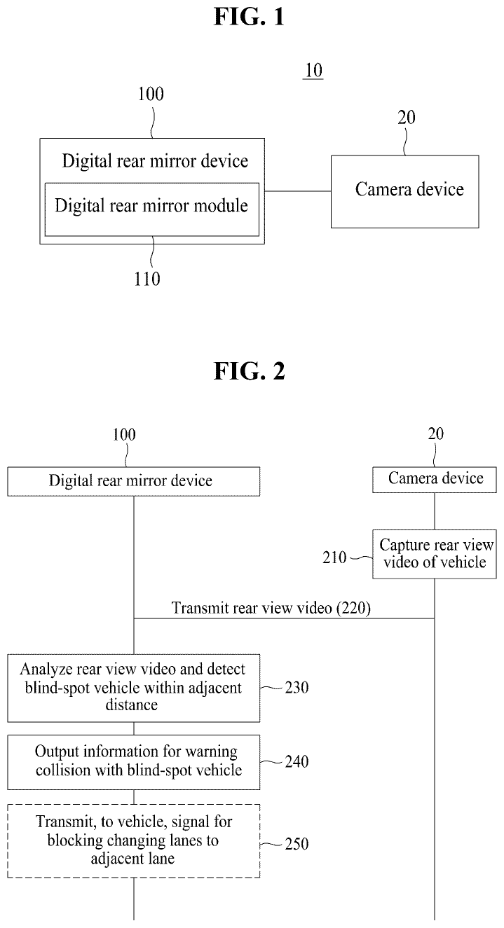

FIG. 1 is a block diagram illustrating a configuration of a video processing system 10 according to various example embodiments.

Referring to FIG. 1, the video processing system 10 may include a camera device 20 and a digital rear mirror device 100. The video processing system 10 may be mounted to a vehicle. In some example embodiments, at least one another component may be added to the video processing system 10.

The camera device 20 may acquire video information on a surrounding environment of the vehicle. In some example embodiments, the camera device 20 may store the video information in a memory within the camera device 20. The video information may include a rear view video of the vehicle. To this end, the camera device 20 may include a rear camera device mounted on the back of the vehicle to face the rear of the vehicle. In some example embodiments, the video information may further include at least one of a front view video and a side view video of the vehicle. In this case, the camera device 20 may further include at least one of a front camera device mounted on the front of the vehicle to face the front of the vehicle and side camera devices mounted on both sides of the vehicle to face both sides of the vehicle.

For example, the camera device 20 may include at least one of one or more lenses, an image sensor, a flash, and an image signal processor (ISP). For example, in the camera device 20, some of the one or more lenses may have the same lens property (e.g., angle of view, focal distance, autofocus, f number, or optical zoom). The one or more lenses may include a light source lens or a telephoto lens. For example, the image sensor may convert light emitted or reflected from a subject and transmitted through the one or more lenses to an electrical signal, and may acquire an image corresponding to the subject. According to an example embodiment, the image sensors may include, for example, a single image sensor selected from among image sensors with different properties such as a red-green-blue (RGB) sensor, a black and white (BW) sensor, an IF sensor, or a ultraviolet (UV) sensor, a plurality of image sensors with the same property, or a plurality of image sensors with different properties. Each image sensor included in the image sensors may be implemented using, for example, a charged coupled device (CCD) sensor or a complementary metal oxide semiconductor (CMOS) sensor. For example, the flash may include one or more light emitting diodes (e.g., red-green-blue (RGB) LED, white LED, infrared LED, or ultraviolet LED), or a xenon lamp.

The digital rear mirror device 100 may display video information acquired by the camera device 20. To this end, the digital rear mirror device 100 may be connected to the camera device 20. In detail, the digital rear mirror device 100 may include a digital rear mirror module 110. The digital rear mirror module 110 may operate in at least one of a mirror mode and a display mode to provide the rear view of the vehicle. In the mirror mode, the digital rear mirror module 110 may directly illuminate the rear view of the vehicle. In the display mode, the digital rear mirror module 110 may provide the rear view of the vehicle by displaying a rear view video of the vehicle acquired by the camera device 20. To this end, the digital rear mirror module 110 may be provided within a driver's front viewing range.

The camera device 20 and the digital rear mirror device 100 may be communicatively connected in a wired or wireless manner. In some example embodiments, the camera device 20 and the digital rear mirror device 100 may be connected through a communication cable. In an example embodiment, the camera device 20 and the digital rear mirror device 100 may perform communication using an analog method. For example, the analog method may include analogue high definition (AHD). In another example embodiment, the camera device 20 and the digital rear mirror device 100 may perform communication using a digital method. For example, the digital method may include a serial transmission method. In this case, the camera device 20 may include a serializer, and the digital rear mirror device 100 may include a deserializer. However, without being limited thereto, the camera device 20 and the digital rear mirror device 100 may also be connected through internal network communication (e.g., controller area network (CAN) communication) of the vehicle. The camera device 20 and the digital rear mirror device 100 may include various communication chips.

The digital rear mirror device 100 may analyze the rear view video of the vehicle acquired from the camera device 20. According to various example embodiments, the digital rear mirror device 100 may monitor a blind-spot vehicle of the vehicle by analyzing the rear view video. According to an example embodiment, the digital rear mirror device 100 may monitor a blind-spot vehicle by analyzing the rear view video while monitoring the blind-spot vehicle using a radar sensor. According to another example embodiment, the digital rear mirror device 100 may monitor a blind-spot vehicle by analyzing the rear view video without monitoring the blind-spot vehicle using the radar sensor. According to various example embodiments, the digital rear mirror device 100 may monitor an available parking area of the vehicle by analyzing the rear view video.

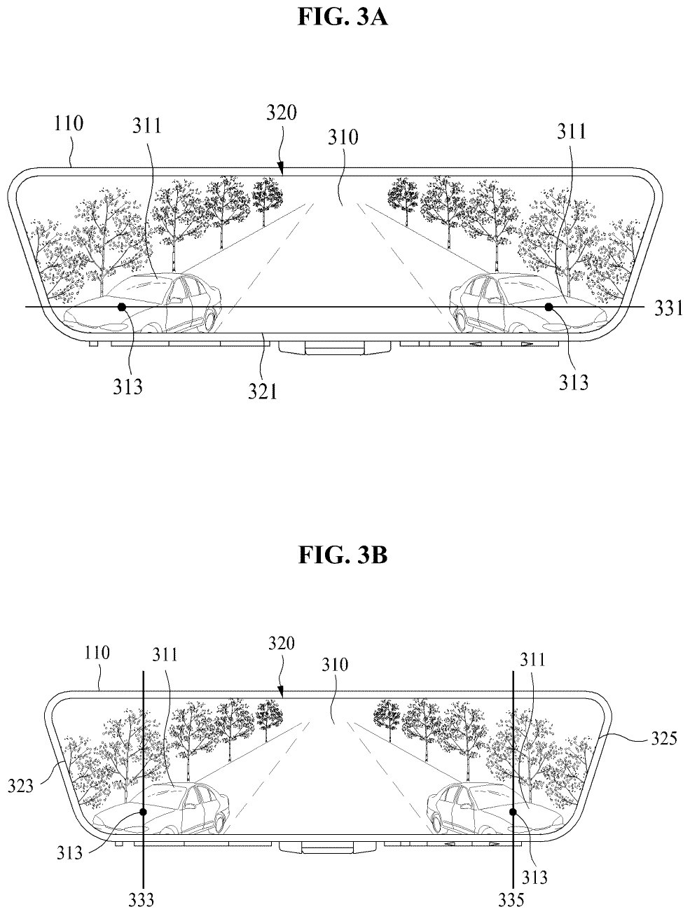

FIG. 2 is a flowchart illustrating signal flow for preventing a collision of a vehicle in the video processing system 10 according to various example embodiments. FIGS. 3A and 3B illustrate examples for describing operation characteristics of the digital rear mirror device 100 for detecting a blind-spot vehicle of a vehicle according to various example embodiments.

Referring to FIG. 2, in operation 210, the camera device 20 may capture a rear view video of the vehicle. Here, the camera device 20 may capture the rear view video at an arbitrary angle. The angle of the camera device 20 may be initially set by default or by a user, and may be changed by the user. Here, the rear view video may have the resolution and the size determined by the camera device 20. Then, in operation 220, the camera device 20 may transmit the rear view video to the digital rear mirror device 100. Accordingly, the digital rear mirror device 100 may receive the rear view video from the camera device 20.

Then, in operation 230, the digital rear mirror device 100 may analyze the rear view video and may detect a blind-spot vehicle 311 within an adjacent distance from the vehicle. The blind-spot vehicle 311 refers to another vehicle that precedes in a lane adjacent to a lane in which the vehicle is traveling and the adjacent lane may include at least one of a left lane and a right lane. The adjacent distance may represent the distance range in which a collision is likely for the vehicle. For example, the adjacent distance may be 2 m to 3 m, but is not limited thereto. The adjacent distance may be initially set by default or by the user, and may be changed by the user.

According to various example embodiments, the digital rear mirror device 100 may display the rear view video through the digital rear mirror module 110. Here, as shown in FIGS. 3A and 3B, the digital rear mirror device 100 may display a field-of-view (FoV) video 310 detected from the rear view video through the digital rear mirror module 110. The FoV video 310 may be at least a portion of the rear view video. Here, the resolution of the FoV video 310 may be the same as the resolution of the rear view video, or may be lower than the resolution of the rear view video. Meanwhile, the size of the FoV video 310 may be the same as the size of the rear view video, or may be smaller than the size of the rear view video. The digital rear mirror module 110 may have a display screen 320 for displaying the FoV video 310. Here, the size of the FoV video 310 may be converted to the size of the display screen 320, for example, enlarged.

According to various example embodiments, the digital rear mirror device 100 may analyze the rear view video while displaying the rear view video through the digital rear mirror module 110. Here, as shown in FIGS. 3A and 3B, the digital rear mirror device 100 may determine whether the blind-spot vehicle 311 is present with the adjacent distance from the vehicle using the FoV video 310. To this end, the adjacent distance may be defined using reference lines 331, 333, and 335 within the display screen 320. Here, the reference line 331, 333, 335 may be set for one edge 321, 323, 325 of the display screen 320, and the adjacent distance may correspond to a distance between the corresponding edge 321, 323, 325 and the reference line 331, 333, 335. That is, the farther the adjacent distance is, the farther the reference line 331, 333, 335 may be set from the corresponding edge 321, 323, 325, and the closer the adjacent distance is, the closer the reference line 331, 333, 335 may be set to the corresponding edge 321, 323, 325. In addition, the reference lines 331, 333, and 335 may be set within the display screen 320 according to an angle of the camera device 20 that captures the rear view video. Therefore, to determine whether the blind-spot vehicle 311 is present within the adjacent distance from the vehicle, the digital rear mirror device 100 may detect a recognition point 313 of the blind-spot vehicle 311 within the FoV video 310 and may determine whether the recognition point 313 is present between the corresponding edge 321, 323, 325 and the reference line 331, 333, 335. Here, the recognition point 313 may be one of the exact center, a vehicle license plate, a front bumper, and a headlight of the blind-spot vehicle 311.

According to an example embodiment, as shown in FIG. 3A, the reference line 331 may be set for the bottom edge 321 of the display screen 320. Here, the reference line 331 may be a horizontal line. In this case, the digital rear mirror device 100 may determine whether the recognition point 313 of the at least one blind-spot vehicle 311 is present in the left lane or the right lane between the bottom edge 321 and the reference line 331.

According to another example embodiment, as shown in FIG. 3B, the reference line 333, 335 may include at least one of the first reference line 333 set for the left edge 323 of the display screen 320 and the second reference line 335 set for the right edge 325 of the display screen 320. Here, each of the first reference line 333 and the second reference line 335 may be a vertical line. In this case, the digital rear mirror device 100 may determine whether the recognition point 313 of the blind-spot vehicle 311 is present in the left lane between the left edge 323 and the first reference line 333. Alternatively or additionally, the digital rear mirror device 100 may determine whether the recognition point 313 of the blind-spot vehicle 311 is present in the right lane between the right edge 325 and the second reference line 335.

Then, in operation 240, the digital rear mirror device 100 may output information for warning a collision with the blind-spot vehicle 311. Here, the digital rear mirror device 100 may output information while displaying the rear view video through the digital rear mirror module 110. This allows a driver of the vehicle to control the vehicle based on the information. As a result, the collision of the vehicle with the blind-spot vehicle 311 may be prevented. Here, the information may be provided as at least one of visual information and auditory information. The visual information may include, for example, at least one of text, icon, indicator, symbol, and image. The auditory information may include, for example, at least one of voice and notification sound.

According to an example embodiment, the digital rear mirror device 100 may output information as visual information. In detail, the digital rear mirror device 100 may output the information as the visual information through the digital rear mirror module 110, or may output the information as the visual information through a separate display module. For example, the digital rear mirror device 100 may display information within the FoV video 310 through the digital rear mirror module 110. According to another example embodiment, the digital rear mirror device 100 may output information as auditory information.

According to some example embodiments, in operation 250, the digital rear mirror device 100 may transmit, to the vehicle, a signal for blocking changing lanes to the adjacent lane in which the blind-spot vehicle 311 is present. Therefore, the vehicle may avoid changing lanes to the adjacent lane based on the signal. For example, the vehicle may automatically avoid changing lanes without responding to the driver's control to change lanes. As a result, the collision of the vehicle with the blind-spot vehicle 311 may be prevented.

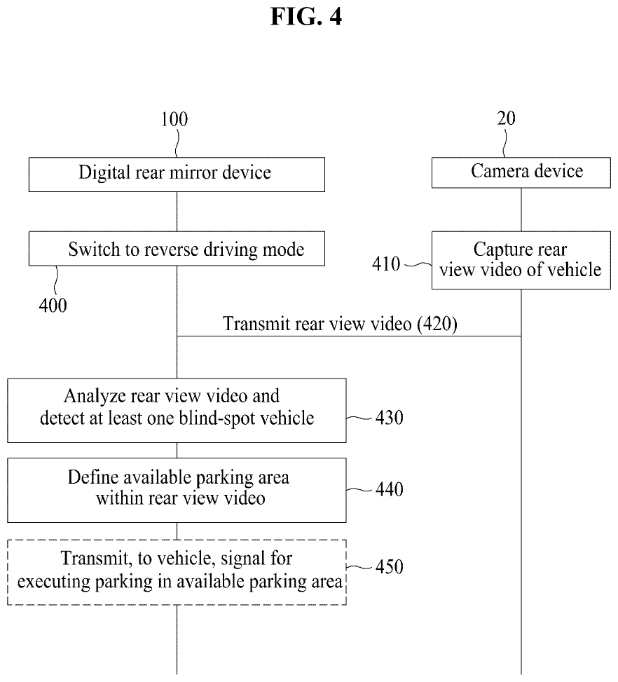

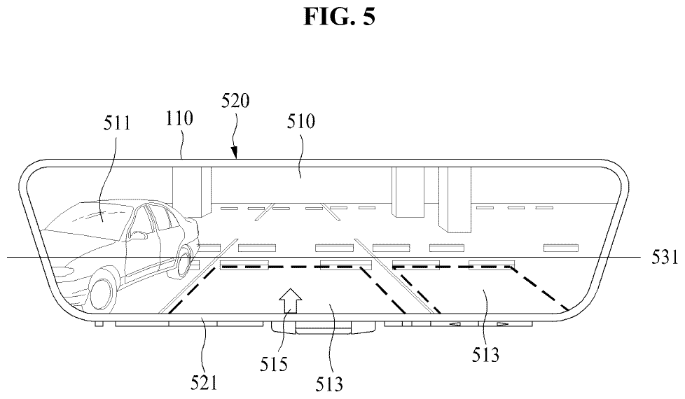

FIG. 4 is a flowchart illustrating signal flow for a vehicle to execute parking in the video processing system 10 according to various example embodiments. FIG. 5 illustrates operation characteristics of the digital rear mirror device 100 for detecting an available parking area of a vehicle according to various example embodiments.

Referring to FIG. 4, in operation 400, the digital rear mirror device 100 may verify a reverse driving mode of the vehicle. In detail, while the reverse driving mode of the vehicle is maintained, the digital rear mirror device 100 may continuously verify the reverse driving mode of the vehicle.

Then, in operation 410, the camera device 20 may capture a rear view video of the vehicle. Here, the camera device 20 may capture the rear view video at an arbitrary angle. The angle of the camera device 20 may be initially set by default or by the user, and may be changed by the user. Here, the rear view video may have the resolution and the size determined by the camera device 20. Then, in operation 420, the camera device 20 may transmit the rear view video to the digital rear mirror device 100. Therefore, the digital rear mirror device 100 may receive the rear view video from the camera device 20.

Then, in operation 430, the digital rear mirror device 100 may analyze the rear view video and may detect at least one available parking area 513. In detail, the digital rear mirror device 100 may detect an empty space within the rear view video and may detect the available parking area 513 within the empty space. Here, the digital rear mirror device 100 may detect the available parking area 513 within an adjacent distance from the vehicle. Here, the adjacent distance may be a length of the vehicle or more. For example, the adjacent distance may be 2 m to 5 m, but is not limited thereto. The adjacent distance may be initially set by default or by the user and may be changed by the user.

According to various example embodiments, the digital rear mirror device 100 may display the rear view video through the digital rear mirror module 110. Here, as shown in FIG. 5, the digital rear mirror device 100 may display a FoV video 510 detected from the rear view video through the digital rear mirror module 110. The FoV video 510 may be at least a portion of the rear view video. Here, the resolution of the FoV video 510 may be the same as the resolution of the rear view video, or may be lower than the resolution of the rear view video. Meanwhile, the size of the FoV video 510 may be the same as the size of the rear view video, or may be smaller than the size of the rear view video. The digital rear mirror module 110 may have a display screen 520 for displaying the FoV video 510. Here, the size of the FoV video 510 may be converted to the size of the display screen 520, for example, enlarged.

According to various example embodiments, the digital rear mirror device 100 may analyze the rear view video while displaying the rear view video through the digital rear mirror module 110. In detail, as shown in FIG. 5, the digital rear mirror device 100 may identify an obstacle 511 within the adjacent distance from the vehicle using the FoV video 510. To this end, the adjacent distance may be defined using a reference line 531 within the display screen 520. Here, the reference line 531 may be set for a bottom edge 521 of the display screen 520, and the adjacent distance may correspond to a distance between the bottom edge 521 and the reference line 531. That is, the farther the adjacent distance is, the farther the reference line 531 may be set from the bottom edge 521, and the closer the adjacent distance is, the closer the reference line 531 may be set to the bottom edge 521. In addition, the reference line 531 may be set within the display screen 520 according to an angle of the camera device 20 that captures the rear view video. Therefore, the digital rear mirror device 100 may identify the obstacle 511 between the bottom edge 521 and the reference line 531 within the FoV video 510. Here, the obstacle 511 may include at least one of the vehicle, a pillar, a wall, a person, an animal, and other objects. Therefore, the digital rear mirror device 100 may detect the empty space without the obstacle 511 within the FoV video 510.

According to various example embodiments, the digital rear mirror device 100 may detect the available parking area 513 within the empty space. According to an example embodiment, the digital rear mirror device 100 may identify parking lines on the floor within the empty space and may detect the available parking area 513 within the empty space based on the parking lines. Additionally, the digital rear mirror device 100 may identify parking availability information on the floor (e.g., information on parking availability for light vehicles, parking availability for disabled persons' vehicles, and parking availability for women's vehicles) within the empty space and may detect the available parking area 513 within the empty space based on the parking availability information with the parking lines. For example, when the parking availability information is identified within the empty space, the digital rear mirror device 100 may detect the parking availability information using parking lines around the parking availability information. As another example, the digital rear mirror device 100 may detect the available parking area 513 having parking availability information that matches the vehicle. According to another example embodiment, the digital rear mirror device 100 may detect the available parking area 513 within the empty space based on the size of the empty space, the size of the vehicle, and a predetermined parking interval. According to still another example embodiment, the digital rear mirror device 100 may identify parking lines on the floor within the empty space, and may detect the available parking area 513 within the empty space based on parking lines, the size of the empty space, the size of the vehicle, and the parking interval.

Then, in operation 440, the digital rear mirror device 100 may define the available parking area 513 within the rear view video. Here, the digital rear mirror device 100 may display the available parking area 513 within the rear view video while displaying the rear view video through the digital rear mirror module 110. Here, the digital rear mirror module 110 may display the two-dimensional (2D) floor surface of the available parking area 513 with lines or colors, or may display the three-dimensional (3D) space of the available parking area 513 with lines or colors. For example, as shown in FIG. 5, the digital rear mirror device 100 may display the available parking area 513 within the FoV video 510 through the digital rear mirror module 110. This allows the driver of the vehicle to control the vehicle to park in the available parking area 513.

According to some example embodiments, in operation 450, the digital rear mirror device 100 may transmit, to the vehicle, a signal for executing parking in the available parking area 513. In detail, the digital rear mirror device 100 may transmit the signal to the vehicle based on a selection on the available parking area 513. Therefore, the vehicle may execute parking in the available parking area 513 based on the signal. For example, as shown in FIG. 5, the digital rear mirror device 100 may display a pointer 515 in the arbitrary available parking area 513. When a plurality of available parking areas 513 are present, the digital rear mirror device 100 may display the pointer 515 in one of the available parking areas 513. Here, the pointer 515 may be moved between the available parking areas 513 by the driver of the vehicle. Therefore, the digital rear mirror device 100 may select the available parking area 513 according to a location of the pointer 515. That is, the digital rear mirror device 100 may select the available parking area 513 in which the pointer 515 is finally located. Then, the digital rear mirror device 100 may generate a signal based on the selected available parking area 513 and may transmit the signal to the vehicle.

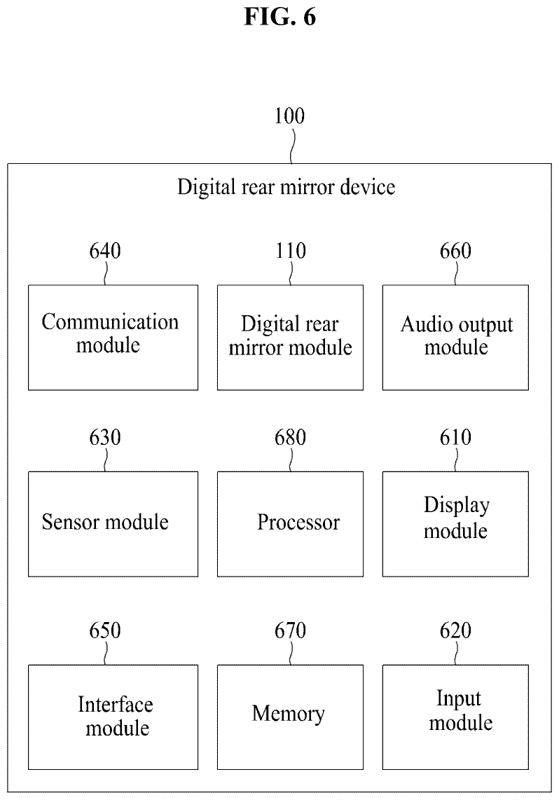

FIG. 6 is a block diagram illustrating a configuration of the digital rear mirror device 100 according to various example embodiments.

Referring to FIG. 6, the digital rear mirror device 100 may be mounted inside the vehicle with the camera device 20 and may be communicatively connected to the camera device 20. In detail, the digital rear mirror device 100 may include at least one of the digital rear mirror module 110, a display module 610, an input module 620, a sensor module 630, a communication module 640, an interface module 650, an audio output module 660, a memory 670, and a processor 680. In some example embodiments, at least one of components of the digital rear mirror device 100 may be omitted and at least one component (e.g., notification module such as light emitting diode (LED) lamp) may be added. In some example embodiments, at least two among components of the digital rear mirror device 100 may be implemented as a single integrated circuit. In an example embodiment, the components of the digital rear mirror device 100 may be integrated into a single unit. In this case, the components of the digital rear mirror device 100 may be accommodated in a single housing. In another example embodiment, the components of the digital rear mirror device 100 may be distributed and configured as at least two units.

The digital rear mirror module 110 may be configured to provide the rear view of the vehicle. To this end, the digital rear mirror module 110 may be provided within the driver's front viewing range. In some example embodiments, the digital rear mirror module 110 may be implemented as a touchscreen by being assembled with a touch circuitry of the input module 620. In some example embodiments, the digital rear mirror module 110 may display video information received from the processor 680. The digital rear mirror module 110 may have the display screen 320, 520 with the predetermined resolution and size. The digital rear mirror module 110 may be accommodated within a housing such that the display screen 320, 520 may be exposed to the outside. In various example embodiments, the digital rear mirror module 110 may operate in at least one of a mirror mode and a display mode. In the mirror mode, the digital rear mirror module 110 may directly illuminate the rear view of the vehicle using light reflection. In the display mode, the digital rear mirror module 110 may provide the rear view of the vehicle by displaying the rear view video received from the processor 680. In various example embodiments, the digital rear mirror module 110 may have an anti-glare function that is activated according to applied voltage. To this end, the digital rear mirror module 110 may be implemented using, for example, an electronic chromic (EC) method or a liquid crystal (LC) method.

The display module 610 may display video information received from the processor 680. For example, the display module 610 may include at least one of a head-up display, a dashboard display, and a side mirror. In some example embodiments, the display module 610 may be implemented as a touchscreen by being assembled with the touch circuitry of the input module 620.

The input module 620 may input a signal to be used for at least one component of the digital rear mirror device 100. The input module 620 may include, for example, at least one of at least one button (also, referable to as key), keyboard, keypad, mouse, joystick, and microphone. For example, the button may be arranged on at least one edge of the digital rear mirror module 110. Here, the button may include at least one of a physical button and a touch button. In some example embodiments, the input module 620 may include the touch circuitry configured to assemble with at least one of the digital rear mirror module 110 and the display module 610.

The sensor module 630 may generate an electrical signal or a data value corresponding to an internal operation state (e.g., power or temperature) of the digital rear mirror device 100. For example, the sensor module 630 may include at least one of a global positioning system (GPS) sensor, a motion sensor (also, referable as gesture sensor), a proximity sensor, a touch sensor, a radar sensor, a light detection and ranging (LIDAR) sensor, a movement sensor, a gyro sensor, a barometric pressure sensor, a magnetic sensor, an acceleration sensor (e.g., G sensor), a proximity sensor, an infrared (IR) sensor, a biosignal sensor, a temperature sensor, a humidity sensor, and an illuminance sensor.

The communication module 640 may communicate with an external device. The communication module 640 may establish a communication channel between the digital rear mirror device 100 and the external device and may communicate with the external device through the communication channel. Here, the external device may include at least one of a satellite, a base station, a server, and an electronic device (e.g., used by the user). The communication module 640 may include at least one of a wired communication module and a wireless communication module. The wired communication module may be connected to the external device in a wired manner and may communicate with the external device in the wired manner. The wireless communication module may include at least one of a near field communication module and a far field communication module. The near field communication module may communicate with the external device using a near field communication scheme. For example, the near field communication scheme may include at least one of Bluetooth, wireless fidelity (WiFi) direct, near field communication (NFC), and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) and a wide area network (WAN).

According to various example embodiments, at least one of the input module 620, the sensor module 630, and the communication module 640 may generate a user input. In an example embodiment, the input module 620 or an arbitrary sensor of the sensor module 630 may generate the user input based on a signal that is directly input from the user. In another example embodiment, the communication module 640 may generate the user input based on a signal that is input from another electronic device used by the user.

The interface module 650 may be provided for connection to an external device. In detail, the interface module 650 may support a designated protocol that may be connected to the external device in a wired or wireless manner. Here, the external device may include at least one of the vehicle and the camera device 20. In an example embodiment, in the case of communicating with the camera device 20 using an analog method, the interface module 650 may receive video information from the camera device 20 and may convert the video information from an analog signal to digital data. In another example embodiment, in the case of communicating with the camera device 20 using a digital method, the interface module 650 may receive video information from the camera device 20 and may convert the video information from serial data to parallel data. In this case, the interface module 650 may be implemented as a deserializer.

The audio output module 660 may output an audio signal generated from the digital rear mirror device 100. For example, the audio output module 660 may include at least one of a speaker and a receiver. In an example embodiment, the audio output module 660 may include at least one voice coil that provides vibration to a diaphragm within the speaker and a magnet capable of forming a magnetic field. When current flows in the voice coil, the magnetic field formed in the voice coil may vibrate the voice coil through interaction with the magnetic field formed by the magnet. The diaphragm connected to the voice coil may vibrate based on vibration of the voice coil. The speaker may output the audio signal based on the vibration of the diaphragm.

The memory 670 may store a variety of data used by at least one component of the digital rear mirror device 100. For example, the memory 670 may include at least one of a volatile memory and a non-volatile memory. Data may include at least one program and input data or output data related thereto. The program may be stored in the memory 670 as software including at least one instruction, and, for example, may include at least one of an operating system (OS), middleware, and an application. The memory 670 may include at least one of a first memory embedded in the digital rear mirror device 100 and a second memory detachably provided to the digital rear mirror device 100.

According to various example embodiments, the memory 670 may store a database in which different adjacent distances and locations of different reference lines 331, 333, 335, 531 within the display screen 320, 520 are mapped. According to some example embodiments, the memory 670 may store a database in which different adjacent distances and locations of different reference lines 331, 333, 335, 531 within the display screen 320, 520 are mapped for combinations of different angles of the camera device 20 that captures the rear view video. For example, the memory 670 may store the database in association with a collision of the vehicle with the blind-spot vehicle 311 as shown in [Table 1] below, and may store the database in association with the empty space of the vehicle as shown in [Table 2] below. Here, values within [Table 1] and [Table 2] may be simply examples and the adjacent distance of [Table 1] and the adjacent distance of [Table 2] may differ from each other or may be the same.

TABLE 1

| Angle of camera | Adjacent | Location of reference line |
|---|---|---|
| device 20 | distance | (distance from corresponding edge) |
| a | 2 m | 2 cm |
| | 3 m | 3 cm |
| — | — | — |
| — | — | — |
| — | — | — |

TABLE 2

| Angle of camera | adjacent | Location of reference line |
|---|---|---|
| device 20 | distance | (distance from corresponding edge) |
| a | 2 m | 2 cm |
| | 3 m | 3 cm |
| | 4 m | 4 cm |
| | 5 m | 5 cm |
| — | — | — |
| — | — | — |
| — | — | — |

The processor 680 may control at least one component of the digital rear mirror device 100. Through this, the processor 680 may perform data processing or operation. For example, hardware for processing data may include an arithmetic and logic unit (ALU), a floating point unit (FPU), a field programmable gate array (FPGA), a central processing unit (CPU), and/or an application processor (AP). The processor 120 may have a structure of a single-core processor or may have a structure of a multi-core processor, such as dual core, quad core, hexa core, and octa core. According to various example embodiments, the processor 680 may execute an instruction stored in the memory 670.

According to various example embodiments, the processor 680 may acquire the rear view video of the vehicle from the camera device 20 through the interface module 650. The processor 680 may display the rear view video through the digital rear mirror module 110. Here, the processor 680 may display the FoV video 310, 510 detected from the rear view video on the display screen 320, 520 of the digital rear mirror module 110.

According to various example embodiments, the processor 680 may analyze the rear view video and may detect the blind-spot vehicle 311 within the adjacent distance from the vehicle. The adjacent distance may represent the distance range in which a collision is likely for the vehicle. To this end, the adjacent distance and the reference line 331, 333, 335 that correspond to each other may be set. The processor 680 may associate the adjacent distance and the reference line 331, 333, 335 based on the database of the memory 670. The adjacent distance may be initially set by default or by the user, and may be changed by the user.

Therefore, the processor 680 may output information for warning a collision with the blind-spot vehicle 311. This allows the driver of the vehicle to control the vehicle based on the information. As a result, the collision of the vehicle with the blind-spot vehicle 311 may be prevented. Here, the information may be provided as at least one of visual information and auditory information. According to an example embodiment, the processor 680 may output the information as the visual information through the digital rear mirror module 110, or may output the information as the visual information through the display module 610. According to another example embodiment, the processor 680 may output the information as the auditory information through the audio output module 660.

According to some example embodiments, the processor 680 may transmit, to the vehicle, a signal for blocking changing lanes to the adjacent lane in which the blind-spot vehicle 311 is present through the interface module 650. Therefore, the vehicle may avoid changing lanes to the adjacent lane based on the signal. As a result, the collision of the vehicle with the blind-spot vehicle 311 may be prevented.

According to various example embodiments, the processor 680 may analyze the rear view video and may detect the at least one available parking area 513. In detail, the processor 680 may detect an empty space within the rear view video and may detect the available parking area 513 within the empty space. Here, the digital rear mirror device 100 may detect the available parking area 513 within the adjacent distance from the vehicle. To this end, the adjacent distance and the reference line 531 that correspond to each other may be set. The processor 680 may associate the adjacent distance and the reference line 531 based on the database of the memory 670. The adjacent distance may be a length of the vehicle or more. The adjacent distance may be initially set by default or by the user and may be changed by the user.

Therefore, the processor 680 may define the available parking area 513 within the rear view video. Here, the processor 680 may display the available parking area 513 within the rear view video while displaying the rear view video through the digital rear mirror module 110. This allows the driver of the vehicle to control the vehicle to park in the available parking area 513.

According to some example embodiments, the processor 680 may transmit, to the vehicle, a signal for executing parking in the available parking area 513 through the interface module 650. In detail, the processor 680 may transmit the signal to the vehicle based on a selection on the available parking area 513. Therefore, the vehicle may execute parking in the available parking area 513 based on the signal. For example, the processor 680 may display the pointer 515 in the arbitrary available parking area 513 through the digital rear mirror module 110. Here, the pointer 515 may be moved. Therefore, the processor 680 may verify a location of the pointer 515 based on a user input and may select the available parking area 513 of the corresponding location. That is, the processor 680 may select the available parking area 513 in which the pointer 515 is finally located. Then, the processor 680 may generate a signal based on the selected available parking area 513 and may transmit the signal to the vehicle.

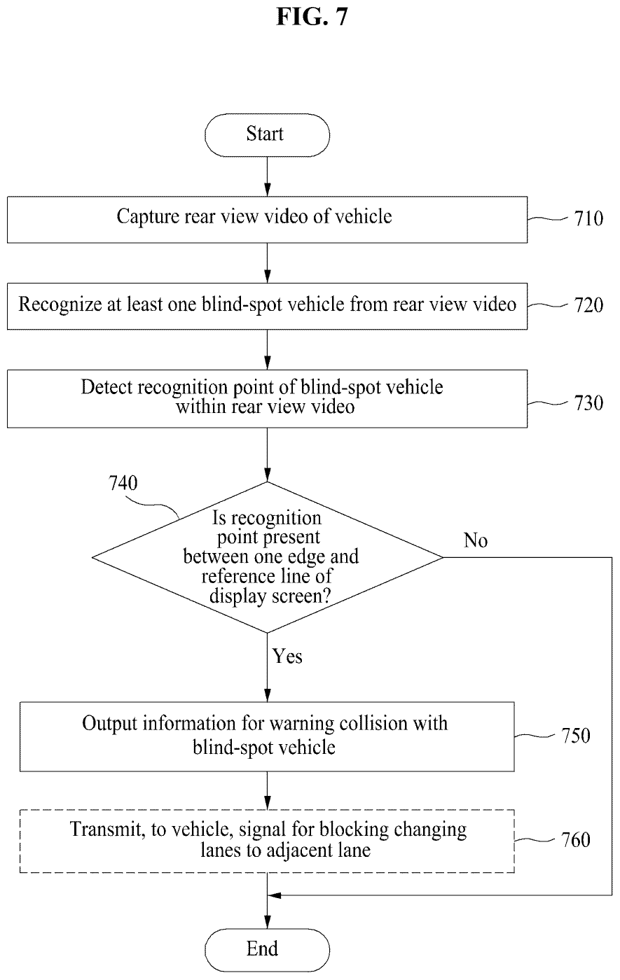

FIG. 7 is a flowchart illustrating an operating method of the digital rear mirror device 100 for detecting the blind-spot vehicle 311 of a vehicle according to various example embodiments.

Referring to FIG. 7, in operation 710, the digital rear mirror device 100 may acquire a rear view video of the vehicle. To this end, the interface module 650 may be communicatively connected to the camera device 20 in a wired or wireless manner. In detail, the camera device 20 may capture the rear view video of the vehicle. Here, the camera device 20 may capture the rear view video at an arbitrary angle. The angle of the camera device 20 may be initially set by default or by a user, and may be changed by the user. Here, the rear view video may have the resolution and the size determined by the camera device 20. Therefore, as the camera device 20 transmits the rear view video to the digital rear mirror device 100, the processor 680 may acquire the rear view video from the camera device 20 through the interface module 650.

According to various example embodiments, the processor 680 may display the rear view video through the digital rear mirror module 110. For example, as shown in FIGS. 3A and 3B, the digital rear mirror device 100 may display the FoV video 310 detected from the rear view video through the digital rear mirror module 110. The FoV video 310 may be at least a portion of the rear view video. Here, the resolution of the FoV video 310 may be the same as the resolution of the rear view video, or may be lower than the resolution of the rear view video. Meanwhile, the size of the FoV video 310 may be the same as the size of the rear view video, or may be smaller than the size of the rear view video. The digital rear mirror module 110 may have the display screen 320 for displaying the FoV video 310. Here, the size of the FoV video 310 may be converted to the size of the display screen 320, for example, enlarged. That is, the processor 680 may display the rear view video on the display screen 320.

Then, in operations 720, 730, and 740, the digital rear mirror device 100 may analyze the rear view video and may detect the blind-spot vehicle 311 within the adjacent distance from the vehicle. The blind-spot vehicle 311 refers to another vehicle that precedes in a lane adjacent to a lane in which the vehicle is traveling and the adjacent lane may include at least one of a left lane and a right lane. The adjacent distance may represent the distance range in which a collision is likely for the vehicle. For example, the adjacent distance may be 2 m to 3 m, but is not limited thereto.

According to various example embodiments, the adjacent distance may be preset. The adjacent distance may be defined using the reference lines 331, 333, and 335 within the display screen 320. That is, the adjacent distances and the reference line 331, 333, and 335 that respectively correspond to each other may be set. Here, the reference line 331, 333, 335 may be set for one edge 321, 323, 325 of the display screen 320, and the adjacent distance may correspond to a distance between the corresponding edge 321, 323, 325 and the reference line 331, 333, 335. That is, the farther the adjacent distance is, the farther the reference line 331, 333, 335 may be set from the corresponding edge 321, 323, 325, and the closer the adjacent distance is, the closer the reference line 331, 333, 335 may be set to the corresponding edge 321, 323, 325. In addition, the reference lines 331, 333, and 335 may be set within the display screen 320 according to an angle of the camera device 20 that captures the rear view video.

According to an example embodiment, as shown in FIG. 3A, the reference line 331 may be set for the bottom edge 321 of the display screen 320. Here, the reference line 331 may be a horizontal line. According to another example embodiment, as shown in FIG. 3B, the reference line 333, 335 may include at least one of the first reference line 333 set for the left edge 323 of the display screen 320 and the second reference line 335 set for the right edge 325 of the display screen 320. Here, each of the first reference line 333 and the second reference line 335 may be a vertical line.

Here, the adjacent distance may be initially set by default or by the user. The adjacent distance may be changed by the user. For example, the processor 680 may associate the adjacent distance and the reference line 331, 333, 335 based on the database of the memory 670 and accordingly, the processor 680 may set the other one of the adjacent distance and the reference line 331, 333, 335 in response to setting of one of the adjacent distance and the reference line 331, 333, 335.

In operation 720, the digital rear mirror device 100 may recognize at least one blind-spot vehicle 311 from the rear view video. The blind-spot vehicle 311 refers to another vehicle that precedes in a lane adjacent to a lane in which the vehicle is traveling and the adjacent lane may include at least one of a left lane and a right lane. In detail, as shown in FIGS. 3A and 3B, the processor 680 may recognize the blind-spot vehicle 311 from the FoV video 310.

Then, in operation 730, the digital rear mirror device 100 may detect the recognition point 313 of the blind-spot vehicle 311 within the rear view video. In detail, as shown in FIGS. 3A and 3B, the processor 680 may detect the recognition point 313 of the blind-spot vehicle 311 within the FoV video 310. Here, the recognition point 313 may be one of the exact center, a vehicle license plate, a front bumper, and a headlight of the blind-spot vehicle 311.

Then, in operation 740, the digital rear mirror device 100 may determine whether the corresponding recognition point 313 is present between the one edge 321, 323, 325 and the reference line 331, 333, 335 on the display screen 320. In detail, the processor 680 may determine whether the corresponding recognition point 313 is present between the corresponding edge 321, 323, 325 of the reference line 331, 333, 335 and the reference line 331, 333, 335. According to an example embodiment, as shown in FIG. 3A, when the reference line 331 is set for the bottom edge 321, the processor 680 may determine whether the recognition point 313 of the at least one blind-spot vehicle 311 is present in the left lane or the right lane between the bottom edge 321 and the reference line 331. According to another example embodiment, as shown in FIG. 3B, when the reference line 333, 335 includes at least one of the first reference line 333 set for the left edge 323 of the display screen 320 and the second reference line 335 set for the right edge 325 of the display screen 320, the processor 680 may determine whether the recognition point 313 of the blind-spot vehicle 311 is present in the left lane between the left edge 323 and the first reference line 333 and, alternatively or additionally, may determine whether the recognition point 313 of the blind-spot vehicle 311 is present in the right lane between the right edge 325 and the second reference line 335.

Then, in operation 750, the digital rear mirror device 100 may output information for warning a collision with the blind-spot vehicle 311. In detail, the processor 680 may output information while displaying the rear view video through the digital rear mirror module 110. This allows the driver of the vehicle to control the vehicle based on the information. As a result, the collision of the vehicle with the blind-spot vehicle 311 may be prevented. Here, the information may be provided as at least one of visual information and auditory information. The visual information may include, for example, at least one of text, icon, indicator, symbol, and image. The auditory information may include, for example, at least one of voice and notification sound.

According to an example embodiment, the processor 680 may output information as visual information. In detail, the processor 680 may output the information as the visual information through the digital rear mirror module 110, or may output the information as the visual information through the display module 610. For example, the processor 680 may display information within the FoV video 310 through the digital rear mirror module 110. As another example, the processor 680 may display the FoV video 310 through the digital rear mirror module 110 and, separate therefrom, may display information through the display module 610. According to another example embodiment, the processor 680 may output information as auditory information through the audio output module 660.

According to some example embodiments, in operation 760, the digital rear mirror device 100 may transmit, to the vehicle, a signal for blocking changing lanes to the adjacent lane in which the blind-spot vehicle 311 is present. In detail, the processor 680 may transmit a signal to the vehicle through the interface module 650. Therefore, the vehicle may avoid changing lanes to the adjacent lane based on the signal. For example, the vehicle may automatically avoid changing lanes without responding to the driver's control to change lanes. As a result, a collision of the vehicle with the blind-spot vehicle 311 may be prevented.

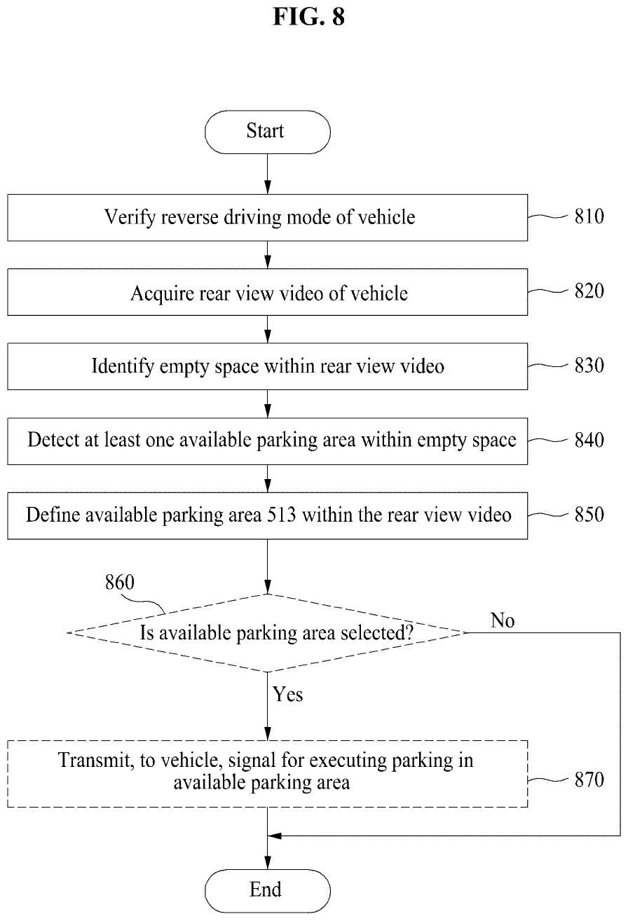

FIG. 8 is a flowchart illustrating an operating method of the digital rear mirror device 100 for detecting the parking are 513 of the vehicle according to various example embodiments.

Referring to FIG. 8, in operation 810, the digital rear mirror device 100 may verify a reverse driving mode of the vehicle. To this end, the interface module 650 may be communicatively connected to the vehicle in a wired or wireless manner. In detail, the processor 680 may verify the reverse driving mode of the vehicle through the interface module 650. While the reverse driving mode of the vehicle is maintained, the processor 680 may continuously verify the reverse driving mode of the vehicle.

Then, in operation 820, the digital rear mirror device 100 may acquire a rear view video of the vehicle. To this end, the interface module 650 may be communicatively connected to the camera device 20 in a wired or wireless manner. In detail, the camera device 20 may capture the rear view video of the vehicle. Here, the camera device 20 may capture the rear view video at an arbitrary angle. The angle of the camera device 20 may be initially set by default or by the user, and may be changed by the user. Here, the rear view video may have the resolution and the size determined by the camera device 20. Therefore, the camera device 20 may transmit the rear view video to the digital rear mirror device 100, and the digital rear mirror device 100 may acquire the rear view video from the camera device 20 through the interface module 650.

According to various example embodiments, the processor 680 may display the rear view video through the digital rear mirror module 110. For example, as shown in FIG. 5, the digital rear mirror device 100 may display the FoV video 510 detected from the rear view video through the digital rear mirror module 110. The FoV video 510 may be at least a portion of the rear view video. Here, the resolution of the FoV video 510 may be the same as the resolution of the rear view video, or may be lower than the resolution of the rear view video. Meanwhile, the size of the FoV video 510 may be the same as the size of the rear view video, or may be smaller than the size of the rear view video. The digital rear mirror module 110 may have the display screen 520 for displaying the FoV video 510. Here, the size of the FoV video 510 may be converted to the size of the display screen 520, for example, enlarged. That is, the processor 680 may display the rear view video on the display screen 520.

Then, in operations 830 and 840, the digital rear mirror device 100 may analyze the rear view video, and may detect the at least one available parking area 513. In detail, the processor 680 may detect an empty space within the rear view video, and may detect the available parking area 513 within the empty space. Here, the digital rear mirror device 100 may detect the available parking area 513 within an adjacent distance from the vehicle. Here, the adjacent distance may be a length of the vehicle or more. For example, the adjacent distance may be 2 m to 5 m, but is not limited thereto. The adjacent distance may be initially set by default or by the user and may be changed by the user.

According to various example embodiments, the adjacent distance may be preset. The adjacent distance may be defined using the reference line 531 within the display screen 520. That is, the adjacent distance and the reference line 531 that correspond to each other may be set. Here, as shown in FIG. 5, the reference line 531 may be set for the bottom edge 521 of the display screen 520, and may be a horizontal line. The adjacent distance may correspond to a distance between the bottom edge 521 and the reference line 531. That is, the farther the adjacent distance is, the farther the reference line 531 may be set from the bottom edge 521, and the closer the adjacent distance is, the closer the reference line 531 may be set to the bottom edge 521. In addition, the reference line 531 may be set within the display screen 520 according to an angle of the camera device 20 that captures the rear view video.

Here, the adjacent distance may be initially set by default or by the user. The adjacent distance and may be changed by the user. For example, the processor 680 may associate the adjacent distance and the reference line 531 based on the database of the memory 670 and accordingly, the processor 680 may set the other one of the adjacent distance and reference line 531 in response to setting of one of the adjacent distance and the reference line 531.

In operation 830, the digital rear mirror device 100 may identify the empty space within the rear view video. In detail, as shown in FIG. 5, the processor 680 may identify the obstacle 511 within the adjacent distance from the vehicle using the FoV video 510. The processor 680 may identify the obstacle 511 between the bottom edge 521 and the reference line 531 within the FoV video 510. Here, the obstacle 511 may include at least one of the vehicle, a pillar, a wall, a person, an animal, and other objects. Therefore, the processor 680 may detect the empty space without the obstacle 511 within the FoV video 510.

Then, in operation 840, the digital rear mirror device 100 may detect the available parking area 513 within the empty space. According to an example embodiment, the processor 680 may identify parking lines on the floor within the empty space and may detect the available parking area 513 within the empty space based on the parking lines. Additionally, the processor 680 may identify parking availability information on the floor (e.g., information on parking availability for light vehicles, parking availability for disabled persons' vehicles, and parking availability for women's vehicles) within the empty space and may detect the available parking area 513 within the empty space based on the parking availability information with the parking lines. For example, when the parking availability information is identified within the empty space, the processor 680 may detect the parking availability information using parking lines around the parking availability information. As another example, the processor 680 may detect the available parking area 513 having parking availability information that matches the vehicle. According to another example embodiment, the processor 680 may detect the available parking area 513 within the empty space based on the size of the empty space, the size of the vehicle, and a predetermined parking interval. According to still another example embodiment, the processor 680 may identify parking lines on the floor within the empty space, and may detect the available parking area 513 within the empty space based on parking lines, the size of the empty space, the size of the vehicle, and the parking interval.

Then, in operation 850, the digital rear mirror device 100 may define the available parking area 513 within the rear view video. In detail, the processor 680 may display the available parking area 513 within the rear view video while displaying the rear view video through the digital rear mirror module 110. Here, the processor 680 may display the 2D floor surface of the available parking area 513 with lines or colors, or may display the 3D space of the available parking area 513 with lines or colors. For example, as shown in FIG. 5, the processor 680 may display the available parking area 513 within the FoV video 510 through the digital rear mirror module 110. This allows the driver of the vehicle to control the vehicle to park in the available parking area 513.

According to some example embodiments, in operation 860, the digital rear mirror device 100 may select the available parking area 513. To this end, as shown in FIG. 5, the processor 680 may display the pointer 515 in the arbitrary available parking area 513. When the plurality of available parking areas 513 are present, the processor 680 may display the pointer 515 in one of the available parking areas 513. Here, the pointer 515 may be moved between the available parking areas 513 based on a user input. Therefore, the processor 680 may verify a location of the pointer 515 based on the user input and may select the available parking area 513 of the corresponding location. That is, the processor 680 may select the available parking area 513 in which the pointer 515 is finally located.

Then, in operation 870, the digital rear mirror device 100 may transmit, to the vehicle, a signal for executing parking in the available parking area 513. In detail, the processor 680 may generate a signal for executing parking in the selected available parking area 513. The processor 680 may transmit the signal to the vehicle through the interface module 650. Therefore, the vehicle may execute parking in the available parking area 513 based on the signal.

According to the present disclosure, the digital rear mirror device 100 may promote the blind-spot safety for the vehicle while providing the rear view of the vehicle. In detail, the digital rear mirror device 100 may monitor the blind-spot safety of the vehicle by analyzing the rear view video and by detecting the blind-spot vehicle 311. This allows the digital rear mirror device 100 to monitor the blind-spot vehicle 311 regardless of the radar sensor, that is, regardless of whether the digital rear mirror device 100 includes the radar sensor or uses the radar sensor. Therefore, the digital rear mirror device 100 may prevent a collision of the corresponding vehicle with the blind-spot vehicle 311 by warning the driving of the collision with the blind-spot vehicle 311, or by allowing the vehicle to avoid changing lanes to the adjacent lane in which the blind-spot vehicle 311 is present. Meanwhile, the digital rear mirror device 100 may additionally monitor the blind-spot safety in a reverse driving mode of the vehicle by analyzing the rear view video and by detecting the available parking area 513. Therefore, the digital rear mirror device 100 may assist in parking the vehicle by informing the driver of the available parking area 513 or by allowing the vehicle to execute parking in the available parking area.

In short, the present disclosure provides the digital rear mirror device 100 for detecting the blind-spot vehicle 311 or the available parking area 513 based on the rear view video of the vehicle and an operating method of the same.

In the present disclosure, the operating method of the digital rear mirror device 100 may include acquiring a rear view video of the vehicle (operation 710), analyzing the rear view video and detecting the blind-spot vehicle 311 within an adjacent distance from the vehicle (operations 720, 730, and 740), and outputting information for warning a collision with the blind-spot vehicle 311 (operation 750).

According to various example embodiments, the operating method of the digital rear mirror device 100 may further include transmitting, to the vehicle, a signal for blocking changing lanes to an adjacent lane in which the blind-spot vehicle 311 is present (operation 760), which allows the vehicle to avoid changing lanes to the adjacent lane based on the signal.

According to various example embodiments, the operating method of the digital rear mirror device 100 may further include displaying the rear view video on the display screen 320, and the adjacent distance may correspond to a distance between the reference line 331, 333, 335 set for one edge 321, 323, 325 of the display screen 320 within the display screen 320 and the edge 321, 323, 325.

According to various example embodiments, the detecting the blind-spot vehicle 311 (operations 720, 730, and 740) may include detecting the recognition point 313 of the blind-spot vehicle 311 between the edge 321, 323, 325 and the reference line 331, 333, 335 that correspond to each other (operations 720 and 730).

According to various example embodiments, the reference line 331, 333, 335 may be set within the display screen 320 according to an angle of the camera device 20 that captures the rear view video, along with the adjacent distance.

According to various example embodiments, the recognition point 313 may be one of the exact center, a vehicle license plate, a front bumper, and a headlight of the blind-spot vehicle 311.

According to various example embodiments, the adjacent distance may be initially set by default or by a user, and may be changed by the user.

According to various example embodiments, the corresponding information may include at least one of visual information and auditory information.

According to various example embodiments, the operating method of the digital rear mirror device 100 may further include, in a reverse driving mode of the vehicle, analyzing the rear view video and detecting the at least one available parking area 513 for the vehicle (operations 830 and 840), and defining the available parking area 513 within the rear view video (operation 850).

According to various example embodiments, the operating method of the digital rear mirror device 100 may further include, in response to the available parking area 513 being selected (operation 860), transmitting, to the vehicle, a signal for executing parking in the available parking area 513 (operation 870) and accordingly, the vehicle may execute parking in the available parking area 513 based on the signal.

In the present disclosure, the operating method of the digital rear mirror device 100 of the vehicle may include acquiring a rear view video of the vehicle (operation 820), in a reverse driving mode of the vehicle, analyzing the rear view video and detecting the at least one available parking area 513 for the vehicle (operations 830 and 840), and defining the available parking area 513 within the rear view video (operation 850).

According to various example embodiments, the operating method of the digital rear mirror device 100 may include transmitting, to the vehicle, a signal for executing parking in the available parking area 513 (operation 870) based on the selection on the available parking area 513 (operation 860) and accordingly, the vehicle may execute parking in the available parking area 513 based on the signal.

According to various example embodiments, the detecting the available parking area 513 (operations 830 and 840) may include identifying an empty space and parking lines within the rear view video (operations 830 and 840), and detecting the available parking area 513 within the empty space based on the parking lines (operation 840).

According to various example embodiments, the detecting the available parking area 513 (operations 830 and 840) may include identifying the empty space within the rear view video (operation 830), and detecting the available parking area 513 within the empty space based on the size of the empty space, the size of the vehicle, and a predetermined parking interval (operation 840).

According to various example embodiments, the defining the available parking area 513 (operation 850) may include displaying the available parking area 513 within the rear view video while displaying the rear view video.

In the present disclosure, the digital rear mirror device 100 of the vehicle may include the digital rear mirror module 110 and the processor 680 configured to connect to the digital rear mirror module 110, to acquire a rear view video during driving of the vehicle, and to display the rear view video on the digital rear mirror module 110, and the processor 680 may be configured to analyze the rear view video and to detect the blind-spot vehicle 311 within an adjacent distance from the vehicle, and to output information for warning a collision with the blind-spot vehicle 311.

According to various example embodiments, the processor 680 may be configured to transmit, to the vehicle, a signal for blocking changing lanes to an adjacent lane in which the blind-spot vehicle 311 is present, and accordingly, the vehicle may avoid changing lanes to the adjacent lane based on the signal.

According to various example embodiments, the digital rear mirror module 110 may have the display screen 320 for displaying the rear view video, and the adjacent distance may correspond to a distance between the reference line 331, 333, 335 set for one edge 321, 323, 325 of the display screen 320 within the display screen 320 and the edge 321, 323, 325.

According to various example embodiments, the processor 680 may be configured to detect the recognition point 313 of the blind-spot vehicle 311 between the edge 321, 323, 325 and the reference line 331, 333, 335 that correspond to each other.

According to various example embodiments, the reference line 331, 333, 335 may be set within the display screen 320 according to an angle of the camera device 20 that captures the rear view video, along with the adjacent distance.

According to various example embodiments, the recognition point 313 may be one of the exact center, a vehicle license plate, a front bumper, and a headlight of the blind-spot vehicle 311.

According to various example embodiments, the adjacent distance may be initially set by default or by a user, and may be changed by the user.

According to various example embodiments, the corresponding information may include at least one of visual information and auditory information.

According to various example embodiments, the processor 680 may be configured to, in a reverse driving mode of the vehicle, analyze the rear view video and detect the at least one available parking area 513 for the vehicle, and to define the available parking area 513 within the rear view video.

According to various example embodiments, the processor 680 may be configured to, in response to the available parking area 513 being selected, transmit, to the vehicle, a signal for executing parking in the available parking area 513, and accordingly, the vehicle may execute parking in the available parking area 513 based on the signal.

In the present disclosure, the digital rear mirror device 100 of the vehicle may include the digital rear mirror module 110; and the processor 680 configured to connect to the digital rear mirror module 110, to acquire the rear view video during driving of the vehicle and to display the rear view video on the digital rear mirror module 110, and the processor 680 may be configured to, in the reverse driving mode of the vehicle, analyze the rear view video and detect the at least one available parking area 513 for the vehicle, and to define the available parking area 513 within the rear view video.

According to various example embodiments, the processor 680 may be configured to transmit, to the vehicle, a signal for executing parking in the available parking area 513 based on the selection on the available parking area 513 and accordingly, the vehicle may execute parking in the available parking area 513 based on the signal.

According to various example embodiments, the processor 680 may be configured to identify an empty space and parking lines within the rear view video, and to detect the available parking area 513 within the empty space based on the parking lines.

According to various example embodiments, the processor 680 may be configured to identify the empty space within the rear view video, and to detect the available parking area 513 within the empty space based on the size of the empty space, the size of the vehicle, and a predetermined parking interval.

According to various example embodiments, the processor 680 may be configured to display the available parking area 513 within the rear view video while displaying the rear view video.

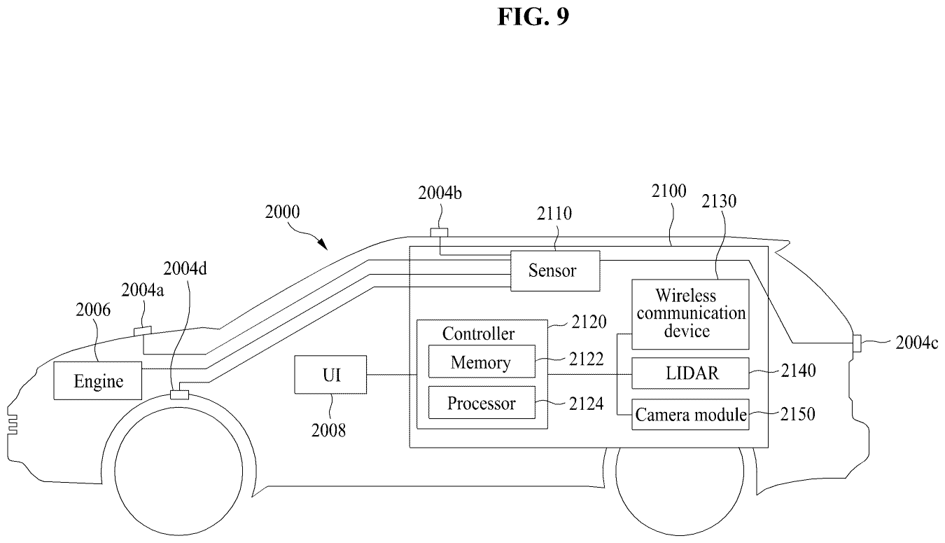

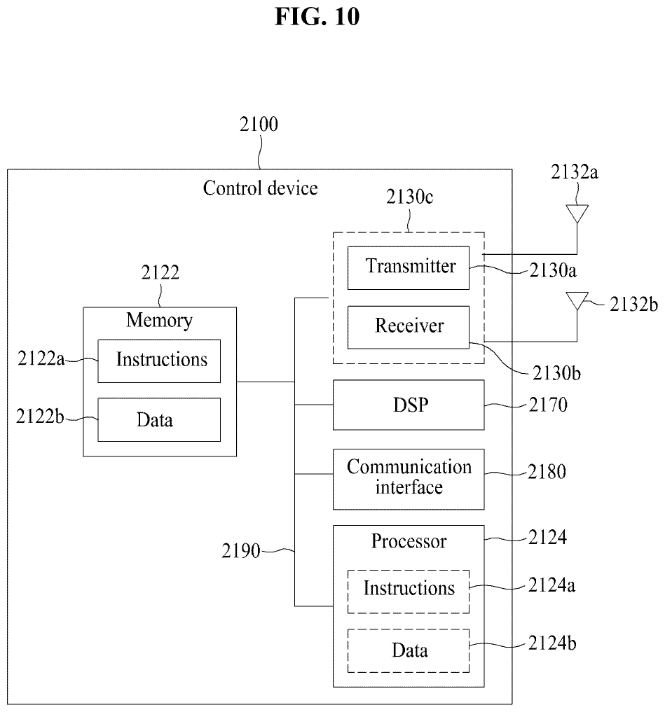

FIG. 9 is a block diagram illustrating a vehicle 2000 to which the video processing system 10 is mounted according to various example embodiments. FIG. 10 is a block diagram illustrating a control device 2100 of the vehicle of FIG. 9.

Referring to FIGS. 9 and 10, the video processing system 10 according to various example embodiments may be mounted to the vehicle 2000 and the vehicle 2000 may include the control device 2100. Here, the vehicle 2000 may be an autonomous vehicle. In some example embodiments, at least one component of the electronic device 100 may be integrated into at least one component of the video processing system 10.

The control device 2100 may include a controller 2120 that includes a memory 2122 and a processor 2124, a sensor 2110, a wireless communication device 2130, a LiDAR device 2140, and a camera module 2150.

The controller 2120 may be configured at a time of manufacture by a manufacturing company of the vehicle or may be additionally configured to perform an autonomous driving function after manufacture. Alternatively, a configuration to continuously perform an additional function by upgrading the controller 2120 configured at the time of manufacture may be included.

The controller 2120 may forward a control signal to the sensor 2110, an engine 2006, a user interface (UI) 2008, the wireless communication device 2130, the LIDAR device 2140, and the camera module 2150 included as other components in the vehicle. Also, although not illustrated, the controller 2120 may forward a control signal to an acceleration device, a braking system, a steering device, or a navigation device associated with driving of the vehicle.

The controller 2120 may control the engine 2006. For example, the controller 2120 may sense a speed limit of a road on which the vehicle 2000 is driving and may control the engine 2006 such that a driving speed may not exceed the speed limit, or may control the engine 2006 to increase the driving speed of the vehicle 2000 within the range of not exceeding the speed limit. Additionally, when sensing modules 2004a, 2004b, 2004c, and 2004d sense an external environment of the vehicle and forward the same to the sensor 2110, the controller 2120 may receive external environment information, may generate a signal for controlling the engine 2006 or a steering device (not shown), and thereby control driving of the vehicle.

When another vehicle or an obstacle is present in front of the vehicle, the controller 2120 may control the engine 2006 or the braking system to decrease the driving speed and may also control a trajectory, a driving route, and a steering angle in addition to the speed. Alternatively, the controller 2120 may generate a necessary control signal according to recognition information of other external environments, such as, for example, a driving lane, a driving signal, etc., of the vehicle, and may control driving of the vehicle.

The controller 2120 may also control driving of the vehicle by communicating with a nearby vehicle or a central server in addition to autonomously generating the control signal and by transmitting an instruction for controlling peripheral devices based on the received information.

Further, if a location or an angle of view of the camera module 2150 is changed, it may be difficult for the controller 2120 to accurately recognize a vehicle or a lane. To prevent this, the controller 2120 may generate a control signal for controlling a calibration of the camera module 2150. Therefore, the controller 2120 may generate a calibration control signal for the camera module 2150 and may continuously maintain a normal mounting location, direction, angle of view, etc., of the camera module 2150 regardless of a change in a mounting location of the camera module 2150 by a vibration or an impact occurring due to a motion of the autonomous vehicle 2000. When prestored information on an initial mounting location, direction, and angle of view of the camera module 2120 differs from information on the initial mounting location, direction, and angle of view of the camera module 2120 that are measured during driving of the autonomous vehicle 2000 by a threshold or more, the controller 2120 may generate a control signal for performing calibration of the camera module 2120.

The controller 2120 may include the memory 2122 and the processor 2124. The processor 2124 may execute software stored in the memory 2122 in response to the control signal of the controller 2120. In detail, the controller 2120 may store, in the memory 2122, data and instructions for detecting a visual field view from a rear view video of the vehicle 2000, and the instructions may be executed by the processor 2124 to perform one or more methods disclosed herein.

Here, the memory 2122 may be stored in a recording medium executable at the non-volatile processor 2124. The memory 2122 may store software and data through an appropriate external device. The memory 2122 may include random access memory (RAM), read only memory (ROM), hard disk, and a memory device connected to a dongle.

The memory 2122 may at least store an operating system (OS), a user application, and executable instructions. The memory 2122 may store application data and arrangement data structures.

The processor 2124 may be a controller, a microcontroller, or a state machine as a microprocessor or an appropriate electronic processor.

The processor 2124 may be configured as a combination of computing devices. The computing device may be configured as a digital signal processor, a microprocessor, or an appropriate combination thereof.

Also, the control device 2100 may monitor internal and external features of the vehicle 2000 and may detect a state of the vehicle 2000 using at least one sensor 2110.

The sensor 2110 may include at least one sensing module 2004. The sensing module 2004 may be implemented at a specific location of the vehicle 2000 depending on a sensing purpose. The sensing module 2004 may be provided in a lower portion, a rear end, a front end, an upper end, or a side end of the vehicle 2000 and may be provided to an internal part of the vehicle, a tier, and the like.

Through this, the sensing module 2004 may sense driving information, such as the engine 2006, a tier, a steering angle, a speed, a vehicle weight, and the like, as internal vehicle information. Also, the at least one sensing module 2004 may include an acceleration sensor 2110, a gyroscope, an image sensor 2110, a radar, an ultrasound sensor, a LiDAR sensor, and the like, and may sense motion information of the vehicle 2000.

The sensing module 2004 may receive specific data, such as state information of a road on which the vehicle 2000 is present, nearby vehicle information, and an external environmental state such as weather, as external information, and may sense a vehicle parameter according thereto. The sensed information may be stored in the memory 2122 temporarily or in long-term depending on purposes.

The sensor 2110 may integrate and collect information of the sensing modules 2004 for collecting information generated inside and on outside the vehicle 2000.

The control device 2100 may further include the wireless communication device 2130.

The wireless communication device 2130 is configured to implement wireless communication between the vehicles 2000. For example, the wireless communication device 2130 enables the vehicles 2000 to communicate with a mobile phone of a user, another wireless communication device 2130, another vehicle, a central device (traffic control device), a server, and the like. The wireless communication device 2130 may transmit and receive a wireless signal according to a wireless communication protocol. The wireless communication protocol may be WiFi, Bluetooth, Long-Term Evolution (LTE), code division multiple access (CDMA), wideband code division multiple access (WCDMA), and global systems for mobile communications (GSM). However, it is provided as an example only and the wireless communication protocol is not limited thereto.

Also, the vehicle 2000 may implement vehicle-to-vehicle (V2V) communication through the wireless communication device 2130. That is, the wireless communication device 2130 may perform communication with another vehicle and other vehicles on the roads through the V2V communication. The vehicle 2000 may transmit and receive information, such as driving warnings, traffic information, and environmental information, through the V2V communication and may also request another vehicle for information or may receive a request from the other vehicle. For example, the wireless communication device 2130 may perform the V2V communication using a dedicated short-range communication (DSRC) device or a cellular-V2V (CV2V) device. Also, in addition to the V2V communication, vehicle-to-everything (V2X) communication, communication between the vehicle and another object (e.g., electronic device carried by pedestrian), may be implemented through the wireless communication device 2130.

Also, the control device 2100 may include the LIDAR device 2140. The LIDAR device 2140 may detect an object around the vehicle 2000 during an operation, based on data sensed using a LIDAR sensor. The LIDAR device 2140 may transmit detection information to the controller 2120, and the controller 2120 may operate the vehicle 2000 based on the detection information. For example, when the detection information includes a vehicle ahead driving at a low speed, the controller 2120 may instruct the vehicle to decrease a speed through the engine 2006. Alternatively, the controller 2120 may instruct the vehicle to decrease a speed based on a curvature of a curve the vehicle enters.

The control device 2100 may further include the camera module 2150. The controller 2120 may extract object information from an external image captured from the camera module 2150, and may process the extracted object information using the controller 2120.

Also, the control device 2100 may further include imaging devices configured to recognize an external environment. In addition to the LIDAR device 2140, a radar, a GPS device, a driving distance measurement device (odometry), and other computer vision devices may be used. Such devices may selectively or simultaneously operate depending on necessity, thereby enabling further precise sensing.

The vehicle 2000 may further include the user interface (UI) 2008 for a user input to the control device 2100. The user interface 2008 enables the user to input information through appropriate interaction. For example, the user interface 2008 may be configured as a touchscreen, a keypad, and a control button. The user interface 2008 may transmit an input or an instruction to the controller 2120, and the controller 2120 may perform a vehicle control operation in response to the input or the instruction.

Also, the user interface 2008 may enable communication between an external device of the vehicle 2000 and the vehicle 2000 through the wireless communication device 2130. For example, the user interface 2008 may enable interaction with a mobile phone, a tablet, or other computer devices.

Further, although the example embodiment describes that the vehicle 2000 includes the engine 2006, it is provided as an example only. The vehicle 2000 may include a different type of a propulsion system. For example, the vehicle 2000 may run with electric energy, and may run with hydrogen energy or through a hybrid system with a combination thereof. Therefore, the controller 2120 may include a propulsion mechanism according to the propulsion system of the vehicle 2000 and may provide a control signal according thereto to each component of the propulsion mechanism.

Hereinafter, a configuration of the control device 2100 of the vehicle 2000 is described with reference to FIG. 10.

The control device 2100 may include the processor 2124. The processor 2124 may be a general-purpose single or multi-chip microprocessor, a dedicated microprocessor, a microcontroller, a programmable gate array, and the like. The processor 2124 may also be referred to as a central processing unit (CPU). Also, the processor 2124 may be a combination of a plurality of processors.

The control device 2100 also includes the memory 2122. The memory 2122 may be any electronic component capable of storing electronic information. The memory 2122 may include a combination of memories 2122 in addition to a unit memory.

According to various example embodiments, data and instructions 2122a of the vehicle 2000 may be stored in the memory 2122. When the processor 2124 executes the instructions 2122a, the instructions 2122a and a portion or all of the data 2122b required to perform command may be loaded to the processor 2124 (2124a and 2124b).

The control device 2100 may include a transmitter 2130a and a receiver 2130b, or a transceiver 2130c, to allow transmission and reception of signals. One or more antennas 2132a and 2132b may be electrically connected to the transmitter 2130a and the receiver 2130b, or the transceiver 2130c, and may include additional antennas.

The control device 2100 may include a digital signal processor (DSP) 2170, and may control the vehicle to quickly process a digital signal through the DSP 2170.

The control device 2100 may also include a communication interface 2180. The communication interface 2180 may include one or more ports and/or communication modules configured to connect other devices to the control device 2100. The communication interface 2180 may enable interaction between the user and the control device 2100.

Various components of the control device 2100 may be connected through one or more buses 2190, and the buses 2190 may include a power bus, a control signal bus, a state signal bus, and a database bus. The components may forward mutual information through the buses 2190 under control of the processor 2124 and may perform desired functions.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of record methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein may include a unit configured as hardware, software, or firmware, and may be interchangeably used with the terms, for example, “logic,” “logic block,” “part,” “circuit,” etc. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. An operating method of a digital rear mirror device of a vehicle, the method comprising:
acquiring a rear view video of the vehicle;
analyzing the rear view video and detecting a blind-spot vehicle within an adjacent distance from the vehicle; and
outputting information for warning a collision with the blind-spot vehicle.

2. The method of claim 1, further comprising:
transmitting, to the vehicle, a signal for blocking changing lanes to an adjacent lane in which the blind-spot vehicle is present, which allows the vehicle to avoid changing lanes to the adjacent lane based on the signal.

3. The method of claim 1, further comprising:
displaying the rear view video on a display screen,
wherein the adjacent distance corresponds to a distance between reference line set for one edge of the display screen within the display screen and the edge.

4. The method of claim 3, wherein the detecting of the blind-spot vehicle comprises detecting a recognition point of the blind-spot vehicle between the edge and the reference line.

5. The method of claim 3, wherein the reference line is set within the display screen according to an angle of a camera device that captures the rear view video, along with the adjacent distance.

6. The method of claim 1, wherein the adjacent distance is initially set by default or by a user, and changeable by the user.

7. The method of claim 1, further comprising:
in a reserve driving mode of the vehicle, analyzing the rear view video and detecting at least one available parking area for the vehicle; and
defining the available parking area within the rear view video.

8. The method of claim 7, further comprising:
in response to the available parking area being selected, transmitting, to the vehicle, a signal for executing parking in the available parking area, which allows the vehicle to execute parking in the available parking area based on the signal.

9. The method of claim 7, wherein the detecting of the available parking area comprises:
identifying an empty space and parking lines within the rear view video; and
detecting the available parking area within the empty space based on the parking lines.

10. The method of claim 7, wherein the detecting of the available parking area comprises:
identifying an empty space within the rear view video; and
detecting the available parking area within the empty space based on a size of the empty space, a size of the vehicle, and a predetermined parking interval.

11. A digital rear mirror device of a vehicle, comprising:
a digital rear mirror module; and
a processor configured to connect to the digital rear mirror module, to acquire a rear view video during driving of the vehicle, and to display the rear view video on the digital rear mirror module,
wherein the processor is configured to,
analyze the rear view video and detect a blind-spot vehicle within an adjacent distance from the vehicle, and
output information for warning a collision with the blind-spot vehicle.

12. The digital rear mirror device of claim 11, wherein the processor is configured to transmit, to the vehicle, a signal for blocking changing lanes to an adjacent lane in which the blind-spot vehicle is present, which allows the vehicle to avoid changing lanes into the adjacent lane based on the signal.

13. The digital rear mirror device of claim 11, wherein the digital rear mirror module has a display screen for displaying the rear view video, and
the adjacent distance corresponds to a distance between reference line set for one edge of the display screen within the display screen and the edge.

14. The digital rear mirror device of claim 13, wherein the processor is configured to detect a recognition point of the blind-spot vehicle between the edge and the reference line.

15. The digital rear mirror device of claim 13, wherein the reference line is set within the display screen according to an angle of a camera device that captures the rear view video, along with the adjacent distance.

16. The digital rear mirror device of claim 11, wherein the adjacent distance is initially set by default or by a user, and changeable by the user.

17. The digital rear mirror device of claim 11, wherein the processor is configured to,
in a reserve driving mode of the vehicle, analyze the rear view video and detect at least one available parking area for the vehicle, and
define the available parking area within the rear view video.

18. The digital rear mirror device of claim 17, wherein
the processor is configured to, in response to the available parking area being selected, transmit, to the vehicle, a signal for executing parking in the available parking area, which allows the vehicle to execute parking in the available parking area based on the signal.

19. The digital rear mirror device of claim 17, wherein the processor is configured to,
identify an empty space and parking lines within the rear view video, and
detect the available parking area within the empty space based on the parking lines.

20. The digital rear mirror device of claim 17, wherein the processor is configured to,
identify an empty space within the rear view video, and
detect the available parking area within the empty space based on a size of the empty space, a size of the vehicle, and a predetermined parking interval.
